(19) United States
(12) Patent Application Publication
(10) Pub. No.: US 2020/0012320 A1
(43) Pub. Date: Jan. 9, 2020

(54) DISPLAY SCREENS AND DISPLAY DEVICES

(71) Applicant: Kunshan Go-Visionox Opto-Electronics Co., Ltd., Kunshan (CN)

(72) Inventors: Min ZOU, Kunshan (CN); Xin YE, Kunshan (CN); Xiaoxu HU, Kunshan (CN)

(21) Appl. No.: 16/571,201

(22) Filed: Sep. 16, 2019

Related U.S. Application Data
(63) Continuation of application No. PCT/CN2018/089387, filed on May 31, 2018.

(30) Foreign Application Priority Data
Oct. 31, 2017 (CN) 201721426691.7

(51) Int. Cl. G06F 1/16

(52) U.S. Cl. CPC G06F 1/1647; G06F 1/1652; G06F 1/1616

(57) ABSTRACT

A display screen and a display device are provided. The display screen having an effective display area includes: a first display area, and a second display area adjacent to the first display area. The first display area and the second display area are non-coplanar. The effective display area has at least one chamfered area. At least a portion of the chamfered area is distributed in the second display area, and a pixel unit is distributed along a chamfered contour line of the chamfered area to fit a chamfered contour line of the chamfered area.

### CROSS REFERENCE TO RELATED APPLICATIONS

This application is a continuation application of International Application PCT/CN2018/089387, filed on May 31, 2018, which claims the priority benefit of Chinese Patent Application No. 201721426691.7, titled “DISPLAY PANEL AND DISPLAY DEVICE” and filed on Oct. 31, 2017. The entireties of both applications are incorporated by reference herein for all purposes.

### TECHNICAL FIELD

The present disclosure relates to the field of display technologies.

### BACKGROUND

Display screens are widely used in various electronic devices. In order to meet display needs of different types of devices, flexible screens have gradually become a research hotspot. Compared with a traditional screen, the flexible screen has obvious advantages, whose bendable and flexible characteristics enable the flexible screen more durable than the traditional screen.

### SUMMARY

Accordingly, a display screen is provided in the present disclosure. The display screen has an effective display area, and includes: a first display area, and a second display area adjacent to the first display area. The first display area and the second display area are non-coplanar. The effective display area has at least one chamfered area, and at least a portion of the chamfered area is distributed in the second display area. A pixel unit is distributed along a chamfered contour line to fit the chamfered contour line of the chamfered area.

In an embodiment, when the chamfered area is entirely distributed in the second display area, the first display area has a first boundary side and a bend-starting side intersected with the first boundary side, the second display area has a second boundary side, the first boundary side and the second boundary side are connected by the chamfered contour line.

In an embodiment, the bend-starting side is intersected with the chamfered contour line at an end of the chamfered contour line.

In an embodiment, a width of the second display area from the bend-starting side to the second boundary side ranges from 4 mm to 6 mm.

In an embodiment, a length of the first boundary side is not smaller than a length of the second boundary side.

In an embodiment, when the chamfered area is entirely distributed in the second display area, the first display area has a first bend-starting side and a second bend-starting side intersected with the first bend-starting side, the second display area has a first boundary side and a second boundary side, the first boundary side and the second boundary side are connected by the chamfered contour line.

In an embodiment, the first bend-starting side and the second bend-starting side are intersected with the chamfered contour line at different ends of the chamfered contour line, respectively.

In an embodiment, when a portion of the chamfered area is distributed in the first display area, the first display area has a first boundary side intersected with the chamfered contour line at an end of the chamfered contour line and a bend-starting side intersected with the chamfer contour line at a non-endpoint of the chamfer contour line, the second display area has a second boundary side, and the first boundary side and the second boundary side are connected by the chamfered contour line.

A display device is further provided in the present disclosure, having the afore-mentioned display screen.

The display screen and the display device provided in the present disclosure have at least the following beneficial effects:

Since the effective display area has at least one chamfered area, the chamfered area is distributed in the second display area, the first display area and the second display area are non-coplanar, the jagged display effect can be visually reduced.

### BRIEF DESCRIPTION OF THE DRAWINGS

FIG. 1 is a schematic diagram of a display screen having a chamfered area in an effective display area in accordance with an embodiment of the present disclosure.

FIG. 2 is schematic diagram of a display screen having a chamfered area in an effective display area in accordance with another embodiment of the present disclosure.

FIG. 3 is a schematic diagram of a display screen having a chamfered area in an effective display area in accordance with still another embodiment of the present disclosure.

### DETAILED DESCRIPTION OF THE INVENTION

The present disclosure relates to a display screen having a chamfered area in an effective display area.

In a process of implementing display technology, there are various challenges. For example, an edge of a flexible screen body has a chamfer, which often causes an obvious jagged display effect when displaying, thereby degrading the display quality.

In a specific application, the display screen can be a computer display, a screen of an LCD TV, a screen of a mobile phone, and the like.

The display screen has a contour line defining the effective display area. The effective display area is generally filled with pixel units that can emit light for showing pictures or dynamically displaying images. When the effective display area is provided with a touch sensor, a motion of an operator can further be sensed and responded.

The pixel unit may generally include a first sub-pixel, a second sub-pixel, and a third sub-pixel. The first sub-pixel, the second sub-pixel, and the third sub-pixel emit light of different colors, respectively. For example, the first sub-pixel, the second sub-pixel, and the third sub-pixel can emit any light of three colors of red (R), green (G), and blue (B), but the first sub-pixel, the second sub-pixel, and the third sub-pixel emit lights of different colors respectively, so as to be mixed to finally show a rich color.

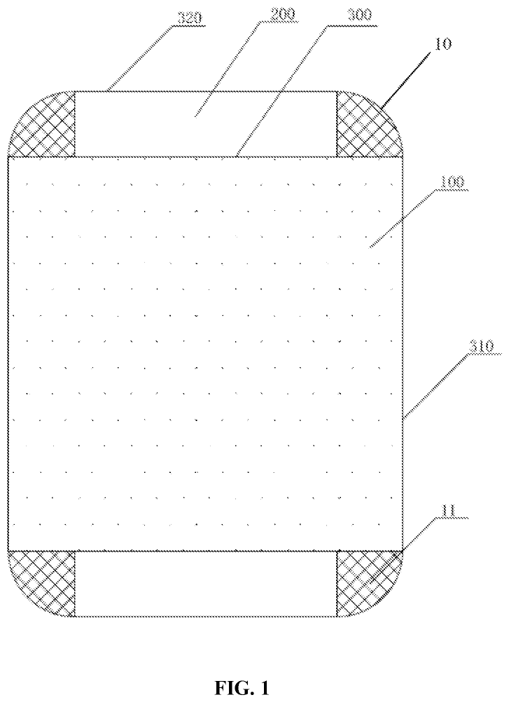

Referring to FIG. 1, the display screen provided herein, having a chamfered area in an effective area, includes a first display area 100 and a second display area 200 adjacent to the first display area 100.

An area occupied by the first display area 100 is substantially over 80 percent of a total area of the display screen, and the first display area 100 is a main display area of the display screen. The afore-described pixel unit is periodically and repeatedly arranged in the first display area 100 for displaying an image. The first display area 100 has a first boundary side 310 and a bend-starting side 300 intersected with the first boundary side 310.

An area occupied by the second display area 200 is within 20 percent of the total area of the display screen, and the second display area 200 is an edge display area of the display screen. Similarly, the aforementioned pixel unit is periodically and repeatedly arranged in the second display area 200 for displaying an image. The second display area 200 has a second boundary side 320.

For a common square display screen, the first boundary side 310 can be generally served as a long side of the display screen. The second boundary side 320 can be generally served as a short side of the display screen.

In order to meet a special requirement of a user, a corner of the display screen can be designed as a chamfer. A chamfered contour line 10 is a smooth curve connecting the first boundary side 310 and the second boundary side 320. The pixel unit is also distributed in a vicinity of the chamfered contour line 10. Specifically, the pixel unit is distributed along the chamfered contour line 10 to fit the chamfered contour line 10.

The chamfered contour line 10 is generally a smooth circular arc, and the chamfered area 11 can be a sectoral area (a mesh area in FIG. 1) which has a same central angle (for example, 90 degrees) as a central angle corresponding to chamfered contour line 10, and a same arc as the arc of the sector area. The pixel unit or the sub-pixel constituting the pixel unit is usually an entity having a certain size. Therefore, when the pixel unit fits the chamfered contour line 10, or when the pixel unit is distributed along the chamfered contour line 10, a boundary of the pixel unit and the chamfered contour line 10 may be not completely coincided with each other, and a certain gap may exist between the boundary of the pixel unit and the chamfered contour line 10. Thus, the pixel unit distributed near the chamfered contour line 10 may exhibit a jagged display effect when emitting light.

In order to solve the problem of the jagged display effect, the display screen is bent in the present disclosure, so that the chamfered area 11 is shifted from facing a front of the viewer to a side of the viewer, so that the jagged display effect can be weakened.

In an embodiment provided by the present disclosure, a display screen having a chamfered area 11 in an effective display area, includes a first display area 100 and a second display area 200 adjacent to the first display area 100. The first display area 100 and the second display area 200 are non-coplanar. The effective display area has at least one chamfered area 11, and the chamfered area 11 is distributed in the second display area 200. The second display area 200 includes a pixel unit. A pixel unit is distributed along a chamfered contour line 10 to fit the chamfered contour line 10.

Specifically, the first display area 100 is bounded by the first boundary side 310 and the bend-starting side 300, and is located within an area defined by the first boundary side 310 and the bend-starting side 300. The second display area 200 is bounded by the second boundary side 320 and the bend-starting side 300, and is located within an area defined by the second boundary side 320 and the bend-starting side 300. The first display area 100 and the second display area 200 are distributed in different surface with the bend-starting side 300 as a boundary therebetween, that is, the first display area 100 and the second display area 200 are non-coplanar. The chamfered area 11 is distributed in the second display area 200. It is assumed that a light emitting area of the chamfered area 11 is X, an area of an orthographic projection of the chamfered area in the second display area 200 to a front surface of a viewer (a plane where the first display area is located) is smaller than X. The closer the bending angle is to 90 degrees, the smaller the area of the orthographic projection is, and the better the jagged display effect is weakened.

Furthermore, in another embodiment provided by the present disclosure, the first display area 100 has a first boundary side 310 and a bend-starting side 300 intersected with the first boundary side 310. The first boundary side 310 is connected to the chamfered contour line 10.

The chamfered contour line 10 is a smooth curve connecting the first boundary side 310 and the second boundary side 320. Therefore, the first boundary side 310 is connected to the chamfered contour line 10. The bend-starting side 300 herein is intersected with the first boundary side 310. In this way, the chamfered area 11 can be entirely disposed in the second display area, so that the jagged display effect is satisfactorily weakened.

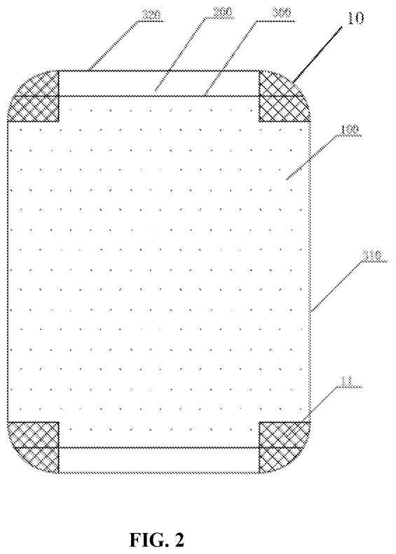

The starting side 300 can be connected to the chamfering contour line 10 according to actual needs. Referring to FIG. 2, in this way, at least a portion of the chamfered area 11 is distributed in the second display area 200, so that the jagged display effect can be partially weakened.

Furthermore, in another embodiment provided by the present disclosure, the second display area 200 has a second boundary side 320. The second boundary side 320 and the first boundary side 310 are respectively connected to opposite ends of the chamfered contour line 10. A width of the second display area 200 from the bend-starting side 300 to the second boundary side 320 ranges from 4 mm to 6 mm.

The chamfered contour line 10 is a smooth curve connecting the first boundary side 310 and the second boundary side 320. Under the premise that the chamfered area 11 is disposed in the second display area 200 to reduce the jagged display effect, the size of the second display area 200 can be flexibly defined. For example, according to actual experience, the chamfering contour line 10 preferably has a size of a quarter arc of a circle, and a radius of the circle is preferably 4 mm to 6 mm. In this way, a balance can be achieved between weakening the jagged display effect and maintaining the front surface of the display screen facing the viewer to be relatively large so as to achieve a good display effect.

Furthermore, in another embodiment provided by the present disclosure, a length of the second boundary side 320 is no greater than a length of the first boundary side 310.

In other words, the second display area 200 is distributed on both sides of the first display area 100 in a longitudinal direction of the first display area 100. In this way, a proper aspect ratio of the first display area can be ensured, and a narrow size in a width direction of the first display area 100 can be avoided, that is, an unproper aspect ratio of the first display area 100 can be avoided.

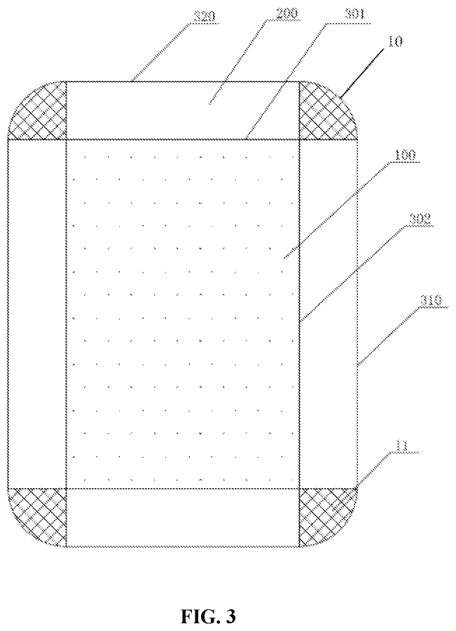

As shown in FIG. 3, in another embodiment provided by the present disclosure, the first display area 100 (a dotted area in FIG. 3) has a first bend-starting side 301 and a second bend-starting side 302 intersected with the first bend-starting side 301.

The second display area 200 has a first boundary side 310, a second boundary side 320, and a chamfered contour line 10 as a smooth curve connecting the first boundary side 310 and the second boundary side 320.

An area occupied by the first display area 100 is substantially more than 80 percent of a total area of the display screen, and the first display area 100 is a main display area of the display screen. The first display area 100 has a first bend-starting side 301 and a second bend-starting side 302. The first display area 100 is an area defined by the first bend-starting side 301 and the second bend-starting side 302. The pixel unit is periodically and repeatedly arranged in the first display area 100 for displaying an image.

An area occupied by the second display area 200 is within 20 percent of the total area of the display screen, and the second display area is an edge display area of the display screen. Similarly, the pixel unit is periodically and repeatedly arranged in the second display area 200 for displaying an image.

The second display area 200 has a first boundary side 310, a second boundary side 320, a chamfered contour line 10 as a smooth curve connecting the first boundary side 310 and the second boundary side 320, a first bend-starting side 301, and a second bend-starting side 302.

For a common square display screen, the first boundary side 310 can be generally served as a long side of the display screen. The second boundary side 320 can be generally served as a short side of the display screen.

Since an edge of the chamfered contour line 10 is generally a smooth circular arc, the pixel unit or the sub-pixel constituting the pixel unit is usually an entity having a certain size. Therefore, when the pixel unit fits the chamfered contour line 10, or when the pixel unit is distributed along the chamfered contour line 10, the boundary of the pixel unit and the chamfered contour line may not completely coincide with each other, and a certain gap may exist therebetween, so that the pixel unit distributed near the chamfered contour line 10 may exhibit a jagged display effect when emitting light.

In this embodiment, the second display area 200 is distributed on a side of the first display area 100, or the second display area 200 is shifted from facing a front of the viewer to a side of the viewer by bending, in this case, the chamfering contour line 10 is shifted from the front to the side, thereby weakening the jagged display effect.

Similar to the forgoing embodiments, the chamfered contour line 10 is a smooth curve connecting the first boundary side 310 and the second boundary side 320. Under the premise that the chamfered area 11 is disposed in the second display area 200 for weakening the jagged display effect, a size of the second display area 200 can be flexibly defined. For example, according to actual experience, the chamfering contour line 10 preferably has a size of a quarter arc of a circle, and a radius of the circle is preferably 4 mm to 6 mm. In this way, a balance can be achieved between weakening the jagged display effect and maintaining that a front side of the display screen facing the viewer is relatively large to achieve a good display effect.

For ease of understanding, specific application scenarios of the implementation of the present disclosure are described below.

In a specific application, the display screen can be a computer display, a screen of an LCD TV, a screen of a mobile phone, and the like. When the display screen is provided with the chamfered area 11 according to actual needs, the chamfered contour line 10 is generally a smooth circular arc, and the pixel unit or the sub-pixel constituting the pixel unit is usually an entity having a certain size. Therefore, when the pixel unit fits the chamfered contour line 10, or when the pixel unit is distributed along the chamfered contour line 10, the boundary of the pixel unit and the contour line may not completely coincide with each other, and a certain gap may exist therebetween, thus, the pixel unit distributed near the chamfered contour line 10 may exhibit a jagged display effect when emitting light.

In order to solve this problem, the chamfered area 11 is shifted from the front of the viewer to the side of the viewer. It is assumed that an original area of the chamfered area 11 is X, an orthographic projection of the chamfered area 11 to the front surface facing the viewer becomes a certain ratio of X after being shifted to the side. In addition, the closer the angle of the bend is to 90 degrees, the smaller the area of projection is, and the better the jagged display effect is weakened.

A manner of shifting the chamfered area 11 from the front to the side of the view is bending the chamfered area 11 or the display area including the chamfered area 11. The display screen generally has a rectangular shape. In order to avoid a unproper aspect ratio of the display screen, the relatively longer sides of rectangle area are bent in the present disclosure, so that the chamfered area 11 is shifted from the front to the side. The bending size can be determined according to specific situations. For example, the chamfered area is entirely bent to the side as determined according to actual situations. At this time, the bend-starting side is intersected with the first boundary side. When the chamfered area 11 is partially bent to the side as determined by actual situations, the bend-starting side 300 is intersected with the chamfered contour line 10.

In yet another embodiment provided by the present disclosure, four edges of the rectangular display screen can be bent to shift the chamfered area 11 from the front to the side.

The forgoing embodiments are merely illustrative of several embodiments of the present disclosure, and the description thereof is more specific and detailed, but is not to be construed as limiting the protection scope of the present disclosure. It should be noted that various changes and modifications can be made by those of ordinary skill in the art, without departing from the concepts of the present application premise, which all fall into the protection scope of the present disclosure. Therefore, the protection scope of the present disclosure shall be subject to the protection scope of the claims.

1. A display screen, having an effective display area, comprising:
a first display area, and
a second display area adjacent to the first display area;
wherein:
the first display area and the second display area are non-coplanar,
the effective display area has at least one chamfered area,
at least a portion of the chamfered area is distributed in the second display area, and
a pixel unit is distributed along a chamfered contour line of the chamfered area to fit the chamfered contour line of the chamfered area.

2. The display screen according to claim 1, wherein when the chamfered area is entirely distributed in the second display area, the first display area has a first boundary side and a bend-starting side intersected with the first boundary side, the second display area has a second boundary side, and the first boundary side and the second boundary side are connected by the chamfered contour line.

3. The display screen according to claim 2, wherein the bend-starting side intersects with the chamfered contour line at an end of the chamfered contour line.

4. The display screen according to claim 2, wherein a width of the second display area from the bend-starting side to the second boundary side ranges from 4 mm to 6 mm.

5. The display screen according to claim 2, wherein a length of the first boundary side is not smaller than a length of the second boundary side.

6. The display screen according to claim 1, wherein when the chamfered area is entirely distributed in the second display area, the first display area has a first bend-starting side and a second bend-starting side intersected with the first bend-starting side, the second display area has a first boundary side and a second boundary side, and the first boundary side and the second boundary side are connected by the chamfered contour line.

7. The display screen according to claim 6, wherein the first bend-starting side and the second bend-starting side are intersected with the chamfered contour line at different ends of the chamfered contour line, respectively.

8. The display screen according to claim 1, wherein when a portion of the chamfered area is distributed in the first display area, the first display area has a first boundary side intersected with the chamfered contour line at an end of the chamfered contour line and a bend-starting side intersected with the chamfer contour line at a non-endpoint of the chamfer contour line, the second display area has a second boundary side, and the first boundary side and the second boundary side are connected by the chamfered contour line.

9. A display device, comprising:
a display screen, having an effective display area, and comprising:
a first display area;
a second display area adjacent to the first display area;
wherein, the first display area and the second display area are non-coplanar, the effective display area has at least one chamfered area, at least a portion of the chamfered area is distributed in the second display area, and a pixel unit being distributed along a chamfered contour line to fit the chamfered contour line of the chamfered area.

10. The display device according to claim 9, wherein when the chamfered area is entirely distributed in the second display area, the first display area has a first boundary side and a bend-starting side intersected with the first boundary side, the second display area has a second boundary side, and the first boundary side and the second boundary side are connected by the chamfered contour line.

11. The display device according to claim 10, wherein the bend-starting side intersects with the chamfered contour line at an end of the chamfered contour line.

12. The display device according to claim 10 wherein a width of the second display area from the bend-starting side to the second boundary side ranges from 4 mm to 6 mm.

13. The display device according to claim 10, wherein a length of the first boundary side is larger or equal to a length of the second boundary side.

14. The display screen according to claim 9, wherein when the chamfered area is entirely distributed in the second display area, the first display area has a first bend-starting side and a second bend-starting side intersected with the first bend-starting side, the second display area has a first boundary side and a second boundary side, the first boundary side and the second boundary side are connected by the chamfered contour line.

15. The display device according to claim 14, wherein the first bend-starting side and the second bend-starting side are intersected with the chamfered contour line at different ends of the chamfered contour line, respectively.

16. The display device according to claim 9, wherein when a portion of the chamfered area is distributed in the first display area, the first display area has a first boundary side intersected with the chamfered contour line at an end of the chamfered contour line and a bend-starting side intersected with the chamfer contour line at a non-endpoint of the chamfer contour line, the second display area has a second boundary side, and the first boundary side and the second boundary side are connected by the chamfered contour line.
